(19) United States
(12) Patent Application Publication
(10) Pub. No.: US 2013/0346960 A1
(43) Pub. Date: Dec. 26, 2013

(54) METHOD AND SYSTEM FOR UPDATING AN APPLICATION

(71) Applicant: Infosys Limited, Bangalore (IN)

(72) Inventors: Puneet Gupta, Bangalore (IN); Venkat Kumar Sivaramamurthy, Bangalore (IN); Karthik Gopalakrishnan Vinmani, Bangalore (IN); Chaithanya Kiran Kona, Krishna District (IN); Sudhakar Vusirika, Vijayawada (IN)

(21) Appl. No.: 13/926,410

(22) Filed: Jun. 25, 2013

(30) Foreign Application Priority Data
Jun. 25, 2012 (IN) 2496/CHE/2012

(51) Int. Cl. G06F 9/445

(52) U.S. Cl. CPC G06F 8/65
USPC 717/170

(57) ABSTRACT

A method and system for updating an application residing on a computing apparatus is disclosed. The method involves comparing a version of the application residing on the computing apparatus with an updatable version of the application to determine whether an update is available for the application. The version of the application comprises one or more pages. Further, a page of the one or more pages is associated with a version number. The method also involves determining one or more pages corresponding to the version of the application for which an updatable version of the one or more pages is available. Further, version number of the updatable version of the one or more pages is communicated to the computing apparatus. Thereafter, the one or more pages is updated with the updatable version of the one or more pages, thereby updating the application residing on the computing apparatus without re-installing the application.

### RELATED APPLICATION DATA

This application claims priority to India Patent Application No. 2496/CHE/2012, filed Jun. 25, 2012, the disclosure of which is hereby incorporated by reference in its entirety.

### FIELD OF THE INVENTION

The invention relates generally to updating an application residing on a computing apparatus. In particular, the invention relates to a method and a system for updating an application residing on a computing apparatus without re-installing the application on the computing apparatus.

### BACKGROUND OF THE INVENTION

Nowadays, in the current context of thick client development, pages are tightly interlinked with underlying source code. Further, these pages are made available offline. In such a scenario, these pages can be fetched locally when there is no internet connection. In case if there is an update for these pages or if these pages are to be modified, or there is a need to add new offline pages, an entire application running on a computing apparatus is downloaded. As a result of downloading the entire application, unnecessary bandwidth is consumed and hence increased data consumption charges. In case there are frequent updation in these pages, user experience is impacted.

There exist alternative methods exists which involves fetching these pages online. However, such methods impacts user experience when the pages are loaded slowly as compared to the pages being loaded locally.

Accordingly, there is a need for a method and a system for updating an application residing on a computing apparatus without re-installing the application on the computing apparatus.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a block diagram of a communication network in which various embodiments of the invention may function.

FIG. 2 illustrates a flowchart of a method of updating an application on a computing apparatus in accordance with an embodiment of the invention.

FIG. 3 illustrates a system for updating an application on a computing apparatus in accordance with an embodiment of the invention.

FIG. 4 illustrates a system for updating an application on a computing apparatus in accordance with an exemplary embodiment of the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to method and system for updating an application residing on a computing apparatus. Accordingly, the system components, apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Various embodiments of the invention provide methods and systems for updating an application residing on a computing apparatus. Examples of a computing apparatus may include, but are not limited to, a mobile device, a laptop, a Personal Computer (PC), a Personal Digital Assistant (PDA), a mobile phone, and any hand-held devices. The method involves comparing a version of the application residing on the computing apparatus with an updatable version of the application. The comparison may be performed to determine whether an update is available for the application residing on the computing apparatus. The version of the application comprises one or more pages. Further, a page of the one or more pages is associated with a version number. The method also involves determining one or more pages corresponding to the version of the application for which an updatable version of the one or more pages is available. Upon determining the one or more pages corresponding to the version of the application, version number of the updatable version of the one or more pages is communicated to the computing apparatus. Thereafter, the one or more pages is updated with the updatable version of the one or more pages, thereby updating the application residing on the computing apparatus without re-installing the application.

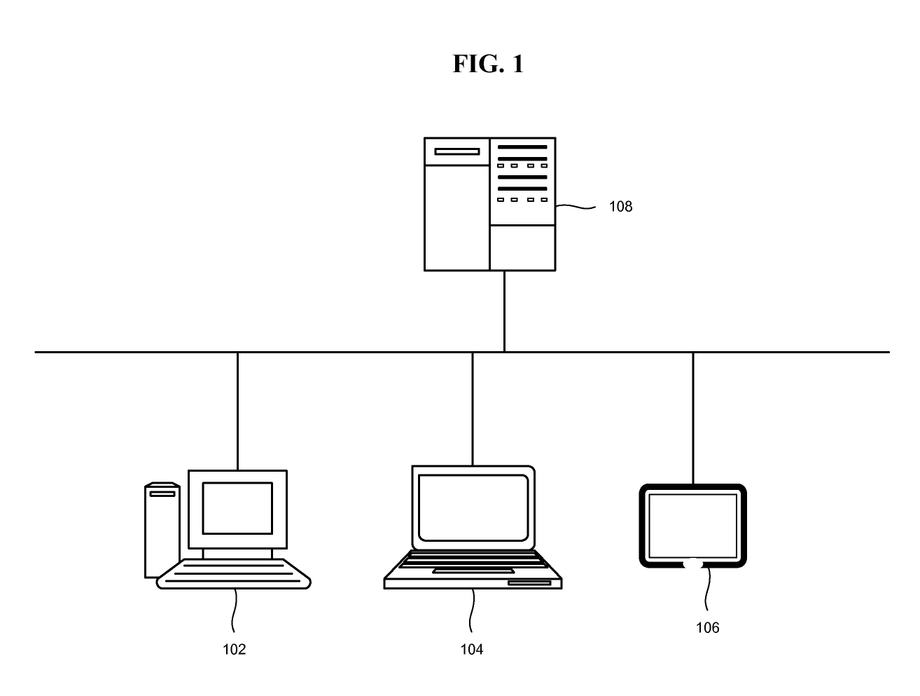

FIG. 1 illustrates a block diagram of a communication network in which various embodiments of the invention may function. The communication network includes one or more computing apparatus which may communicate with a server. In a scenario, the one or more computing apparatus communicate with the server using a wired network. In another scenario, the one or more computing apparatus communicate with the server using a wireless network. As shown in FIG. 1, the one or more computing apparatus include a PC 102, a laptop 104, and a PDA 106. The communication network includes a server 108.

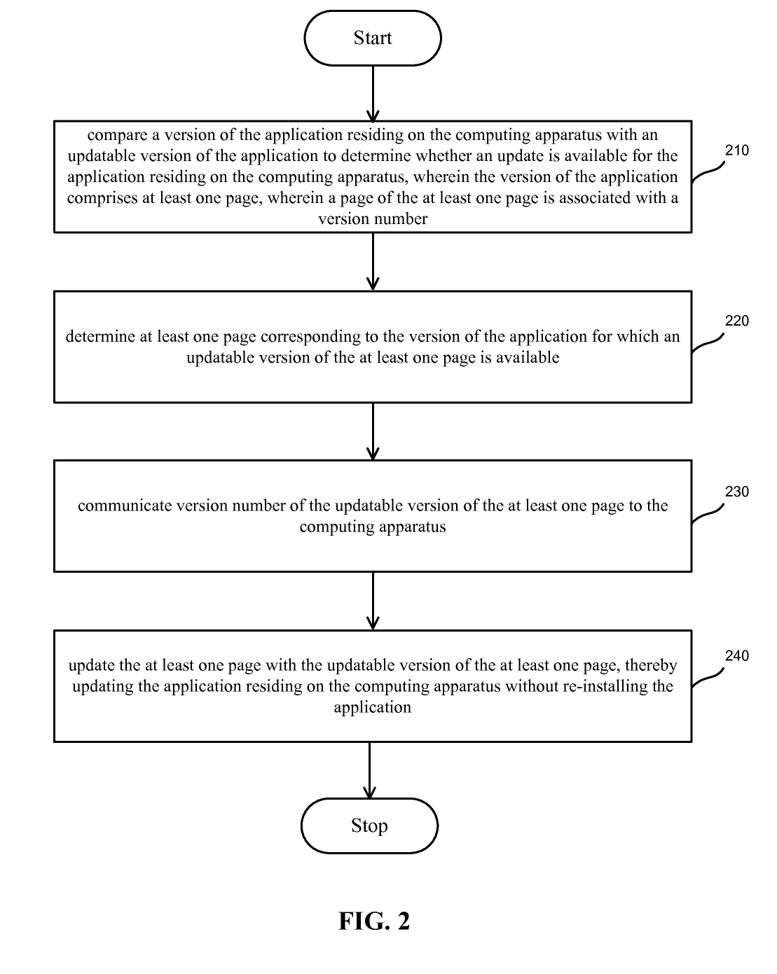

FIG. 2 illustrates a flowchart of a method of updating an application on a computing apparatus in accordance with an embodiment of the invention. Examples of a computing apparatus may include, but are not limited to, a mobile device, a laptop, a Personal Computer (PC), a Personal Digital Assistant (PDA), a mobile phone, and any hand-held devices. As shown in FIG. 2, at step 210, a version of the application residing on the computing apparatus is compared with an updatable version of the application. In a scenario, the updatable version of the application is residing on a server. The comparison may be performed to determine whether an update is available for the application residing on the computing apparatus. The version of the application comprises one or more pages. Further, a page of the one or more pages is associated with a version number.

Further, at step 220, one or more pages corresponding to the version of the application for which an updatable version of the one or more pages is available is determined. In a scenario, the updatable version of the one or more pages is residing on a server. Upon determining the one or more pages corresponding to the version of the application, at step 230, version number of the updatable version of the one or more pages is communicated to the computing apparatus. In a scenario, the version number of the updatable version of the one or more pages is communicated to the computing apparatus from a server. In an embodiment, the computing apparatus may perform a pull operation to fetch the version number of the updatable version of the one or more pages from the server. In a scenario, the computing apparatus may perform a pull operation periodically. The pull operation may be performed either manually or automatically. In another embodiment, the server may perform a push operation to send the version number of the updatable version of the one or more pages to the computing apparatus. In a scenario, the server may perform a push operation periodically. The push operation may be performed either manually or automatically.

Thereafter, at step 240, the one or more pages residing on the computing apparatus is updated with the updatable version of the one or more pages, thereby updating the application residing on the computing apparatus without re-installing the application. In an embodiment, the updation of a page of the one or more pages includes deleting the page. In another embodiment, the updation of a page of the one or more pages includes adding a page. In a scenario, the updation of a page of the one or more pages may include modifying a layout of the one or more pages. In another scenario, the updation of a page of the one or more pages may include modifying a style of the one or more pages. In yet another scenario, the updation of a page of the one or more pages may include updating the content of the one or more pages.

Upon updating the one or more pages residing on the computing apparatus with the updatable version of the one or more pages, the updatable version of the one or more pages may be stored on the computing apparatus. Thereafter, the version number of the application residing on the computing apparatus is updated.

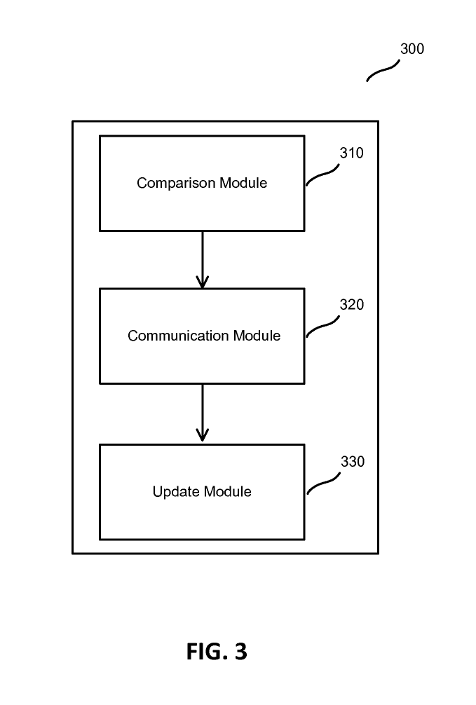

FIG. 3 illustrates a system 300 for updating an application on a computing apparatus in accordance with an embodiment of the invention. Examples of a computing apparatus may include, but are not limited to, a mobile device, a laptop, a Personal Computer (PC), a Personal Digital Assistant (PDA), a mobile phone, and any hand-held devices. As shown in FIG. 3, system 300 includes a comparison module 310 for comparing a version of the application residing on the computing apparatus with an updatable version of the application. In a scenario, the updatable version of the application is residing on a server. The comparison may be performed to determine whether an update is available for the application residing on the computing apparatus. The version of the application comprises one or more pages. Further, a page of the one or more pages is associated with a version number.

Comparison module 300 determines one or more pages corresponding to the version of the application for which an updatable version of the one or more pages is available. System 300 further includes a communication module 320 for communicating version number of the updatable version of the one or more pages to the computing apparatus. In an embodiment, communication module may reside in the server. In such a scenario, the version number of the updatable version of the one or more pages is communicated to the computing apparatus from the server. The computing apparatus may perform a pull operation to fetch the version number of the updatable version of the one or more pages from the communication module 320. The pull operation may be performed either manually or automatically. Alternatively, the computing apparatus may perform a pull operation periodically. In an embodiment, communication module 320 may perform a push operation to send the version number of the updatable version of the one or more pages to the computing apparatus. In a scenario, communication module 320 may perform a push operation periodically. The push operation may be performed either manually or automatically.

System 300 further includes an update module 330 for updating the one or more pages residing on the computing apparatus with the updatable version of the one or more pages, thereby updating the application residing on the computing apparatus without re-installing the application. In an embodiment, the updation of a page of the one or more pages includes deleting the page. In another embodiment, the updation of a page of the one or more pages includes adding a page. In a scenario, the updation of a page of the one or more pages may include modifying a layout of the one or more pages. In another scenario, the updation of a page of the one or more pages may include modifying a style of the one or more pages. In yet another scenario, the updation of a page of the one or more pages may include updating the content of the one or more pages. Upon updating the one or more pages residing on the computing apparatus with the updatable version of the one or more pages, the updatable version of the one or more pages may be stored on the computing apparatus. Thereafter, the version number of the application residing on the computing apparatus is updated.

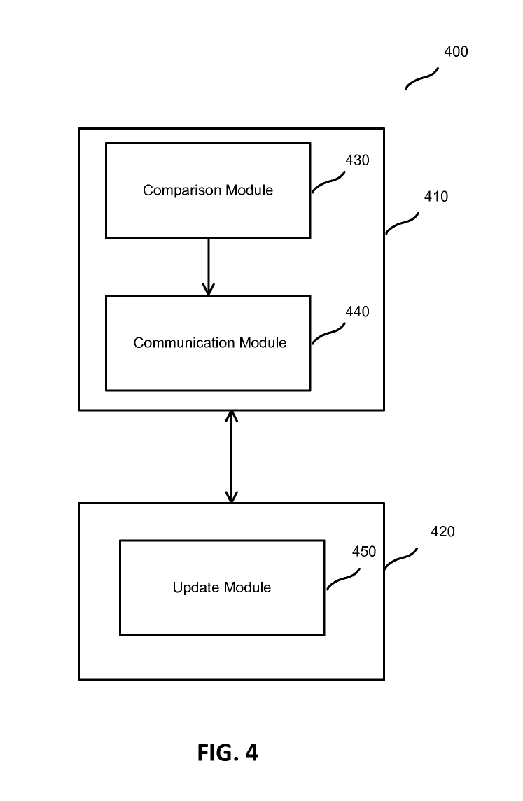

FIG. 4 illustrates a system 400 for updating an application on a computing apparatus in accordance with an exemplary embodiment of the invention. Examples of a computing apparatus may include, but are not limited to, a mobile device, a laptop, a Personal Computer (PC), a Personal Digital Assistant (PDA), a mobile phone, and any hand-held devices. As shown in FIG. 4, system 400 includes a server 410 and a computing apparatus 420. Server 410 is configured to communicate with the computing apparatus 420. Server 410 includes a comparison module 430 for comparing a version of the application residing on computing apparatus 420 with an updatable version of the application. The comparison may be performed to determine whether an update is available for the application residing on the computing apparatus. The version of the application comprises one or more pages. Further, a page of the one or more pages is associated with a version number.

Comparison module 430 determines one or more pages corresponding to the version of the application for which an updatable version of the one or more pages is available. Server 410 further includes a communication module 440 for communicating version number of the updatable version of the one or more pages to computing apparatus 420. The version number of the updatable version of the one or more pages is communicated to computing apparatus 420 from server 410. Computing apparatus 420 may perform a pull operation to fetch the version number of the updatable version of the one or more pages from communication module 440. The pull operation may be performed either manually or automatically. Alternatively, computing apparatus 420 may perform a pull operation periodically. In an embodiment, communication module 440 may perform a push operation to send the version number of the updatable version of the one or more pages to computing apparatus 420. In a scenario, communication module 440 may perform a push operation periodically. The push operation may be performed either manually or automatically.

Computing apparatus 420 includes an update module 450 for updating the one or more pages residing on computing apparatus 420 with the updatable version of the one or more pages, thereby updating the application residing on computing apparatus 420 without re-installing the application. In an embodiment, the updation of a page of the one or more pages includes deleting the page. In another embodiment, the updation of a page of the one or more pages includes adding a page. In a scenario, the updation of a page of the one or more pages may include modifying a layout of the one or more pages. In another scenario, the updation of a page of the one or more pages may include modifying a style of the one or more pages. In yet another scenario, the updation of a page of the one or more pages may include updating the content of the one or more pages. Upon updating the one or more pages residing on computing apparatus 420 with the updatable version of the one or more pages, the updatable version of the one or more pages may be stored on computing apparatus 420. Thereafter, the version number of the application residing on computing apparatus 420 is updated.

Consider an example in which a user launches a retail application on a mobile device. The retail application includes few categories of products for sale. Consider a scenario in which an enterprise adds a new category of a product. In such a scenario, a new version of pages is made available (for e.g. category listing page, list of products in new category along with product details). As the user launches the retail application, the retail application performs a handshake with a server and provides a current version number of the retail application to the server.

The server detects that a new version of the retail application is available. Further, the server instructs the mobile device of the user to delete pages which are obsolete. The obsolete page is deleted from the retail application and updates the version to the new version. As the user accesses the category listing page, new page is updated from the server and as the user access the category list of product and product details are updated from the server. On subsequent access of the pages, the pages are accessed locally. In case the user does not access the specific category information related to the list of product, product details are not updated from the server.

Various embodiments of the present invention provide method and systems for updating an application residing on a computing apparatus. The method involves updating an application residing on a computing apparatus without re-installing the application on the computing apparatus. In case a user is not interested in one or more pages of the application, the one or more pages of the application may not be downloaded on the computing apparatus. As a result, unnecessary bandwidth consumption is reduced and hence reduces data consumption charges. Further, the user experience of using the application is enhanced.

The present description includes the best presently-contemplated method for carrying out the present invention. Various modifications to the embodiment will be readily apparent to those skilled in the art and some features of the present invention may be used without the corresponding use of other features. Accordingly, the present invention is not intended to be limited to the embodiments shown but is to be accorded the widest scope consistent with the principles and features described herein.

As will be appreciated by those ordinary skilled in the art, the aforementioned example, demonstrations, and method steps may be implemented by suitable code on a processor base system, such as general purpose or special purpose computer. It should also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code.

What is claimed is:

1. A method of updating an application residing on a computing apparatus, the method comprising:
comparing a version of the application residing on the computing apparatus with an updatable version of the application to determine whether an update is available for the application residing on the computing apparatus, wherein the version of the application comprises at least one page, wherein a page of the at least one page is associated with a version number;
determining at least one page corresponding to the version of the application for which an updatable version of the at least one page is available;
communicating version number of the updatable version of the at least one page to the computing apparatus; and
updating the at least one page with the updatable version of the at least one page, thereby updating the application residing on the computing apparatus without re-installing the application.

2. The method of claim 1, wherein the updatable version of the application is maintained at a server.

3. The method of claim 1, wherein the updatable version of the page is maintained at a server.

4. The method of claim 1, wherein version number of the updatable version of the at least one page is communicated to the computing apparatus from a server.

5. The method of claim 1, further comprising retrieving the updatable version of the at least one page from a server.

6. The method of claim 5, wherein the updatable version of the page is stored on the computing apparatus.

7. The method of claim 1, wherein updating the at least one page comprises at least one of deleting the at least one page and adding at least one page.

8. The method of claim 1, wherein updating the at least one page comprises at least one of modifying a layout of the at least one page, modifying a style of the at least one page, updating content of the at least one page.

9. A system for updating an application residing on a computing apparatus, the system comprising:
a comparison module configured to:
compare a version of the application residing on the computing apparatus with an updatable version of the application to determine whether an update is available for the application residing on the computing apparatus, wherein the version of the application comprises at least one page, wherein a page of the at least one page is associated with a version number; and
determine at least one page corresponding to the version of the application for which an updatable version of the at least one page is available;
a communication module configured to communicate version number of the updatable version of the at least one page to the computing apparatus; and
an update module configured to update the at least one page with the updatable version of the at least one page, thereby updating the application residing on the computing apparatus without re-installing the application.

10. The system of claim 9, wherein the update module is further configured to delete the at least one page.

11. The system of claim 9, wherein the update module is further configured to add at least one page.

12. The system of claim 9, wherein the update module is further configured to retrieve the updatable version of the at least one page from a server.

13. A computer program product for updating an application residing on a computing apparatus coupled to a computing device, the computer program product comprising a computer usable medium having a computer readable program code embodied therein, the computer readable program code storing a set of instructions configured to:
compare a version of the application residing on the computing apparatus with an updatable version of the application to determine whether an update is available for the application residing on the computing apparatus, wherein the version of the application comprises at least one page, wherein a page of the at least one page is associated with a version number;
determine at least one page corresponding to the version of the application for which an updatable version of the at least one page is available;
communicate version number of the updatable version of the at least one page to the computing apparatus; and
update the at least one page with the updatable version of the at least one page, thereby updating the application residing on the computing apparatus without re-installing the application.
